(19) United States
(12) Patent Application Publication
(10) Pub. No.: US 2013/0059059 A1
(43) Pub. Date: Mar. 7, 2013

(54) FLOWABLE LIQUID COMPOSITION

(71) Applicants: Ian Tristram, Carole Park (AU); Peter Skarshewski, Carole park (AU)

(72) Inventors: Ian Tristram, Carole Park (AU); Peter Skarshewski, Carole park (AU)

(73) Assignee: TRISTRAM PTY LTD, CAROLE PARK, QUEENSLAND (AU)

(21) Appl. No.: 13/697,339

(22) PCT Filed: May 11, 2011
(86) PCT No.: PCT/AU2011/000546

§ 371 Date: Nov. 9, 2012

(30) Foreign Application Priority Data
May 11, 2010 (AU) 2010902014

(51) Int. Cl. A23L 1/05

(52) U.S. Cl. 426/577; 426/573; 426/519

(57) ABSTRACT

The invention provides a stable liquid composition of less than 7500 cP comprising an edible gum/s and viscosity inhibiting carriers, wherein addition of the composition to a hot or cold foodstuff increases the viscosity of the foodstuff to greater than 400 cP. The invention also provides a method of manufacturing the liquid composition and method of using the composition to thicken foodstuff.

### FIELD OF INVENTION

This invention relates to a flowable liquid composition. In particular the invention relates to a flowable liquid composition comprising an edible gum and a viscosity inhibiting carrier for use as a liquid food viscosity regulator.

### BACKGROUND

In the food industry, it is often desirable to add viscosity enhancers to food formulations to increase the viscosity of the end product. Examples of such end products include yoghurts and desserts. It is also often desirable to provide viscous thickened liquids, particularly for the geriatric and convalescent markets. The thickened liquids need to be of a particular, known and repeatable viscosity to be applicable to these markets.

Currently, these products are pre-prepared by mixing the foodstuff with the viscosity enhancer before packaging, and providing the final thickened product already packaged. In some instances, the thickener is provided as a pre-mixed viscous emulsion or gel, which is then added to the food to be thickened, and stirred. It is often difficult to properly mix these gels into the food as the gel is not easily disperse and tends to clump, resulting in lumpy end products.

Viscosity enhancers can also be provided in powdered form for the end user to mix into the food to be thickened, but this presents problems with inconsistencies in incorporating the powder and the potential to incorporate air into very thick products. Also, addition of the powdered thickener usually results in a lumpy, inconsistent product which would not be desirable for consumption, especially for geriatric consumers, or patients suffering from dysphagia.

Dysphagia is a condition where the process of swallowing is impaired. During eating, this can lead to the entry of liquid or solid food into the trachea (windpipe) and lungs (known as aspiration) of the sufferer. Dysphagia can occur at any age but is most common in the elderly, especially if they have suffered a stroke or have dementia. A management strategy for suffers of dysphagia is to consume foods that are texture modified (thickened foods and beverages) that slow the swallowing reflex and allow the windpipe time to close before the food passes, thereby preventing aspiration.

It would be advantageous to provide a composition which could be added in situ to any hot or cold food or beverage to give a thickened liquid of known and repeatable viscosity.

The most commonly used viscosity enhancers used in the food industry are the edible gums. Edible gums are polysaccharides capable of causing a large viscosity increase in solution, even at small concentrations. In the food industry they are used as thickening agents, gelling agents, emulsifiers and stabilisers. Most often these gums are found in the woody elements of plants or in seed coatings. Examples include agar, obtained from seaweed, alginic acid, from seaweed, beta-glucan, from oat or barley bran, carrageenan, from seaweed, guar gum, from guar beans, gum arabic, from the sap of Acacia trees, gum tragacanth, from the sap of Astragalus shrubs, locust bean gum, from the seeds of the carob tree, sodium alginate, from seaweed, and xanthan gum, one example produced by bacterial fermentation.

When these gums are dissolved into aqueous solution, the gums restrict the movement of water molecules and cause a considerable increase in viscosity, from thickening to gel formation.

Generally these gums are provided in powder form and can be difficult to disperse in a solution or foodstuff as they tend to hydrate rapidly before each individual powder particle is dispersed and form clumps and lumps in the solution. It is known that edible gums can be dispersed in a foodstuff by adding the powder into a product using high shear mixing to ensure efficient dispersion, or pre-blending the gum with another powder ingredient to separate the gum particles before they contact water. One of the problems with these techniques is that the gum expresses its viscosity once in solution, making it difficult to dispense the solution unless the gum concentration is low. This has implications for the addition of the solution to the foodstuff, as the viscosity and concentration of the end product will be affected by the amount of solution added.

Also, such solutions are not stable and must be used immediately or preservatised. Hence gum compositions of this type are not prepared, stored or sold in this form, but normally kept in powdered form until just prior to use in the production of the food product.

In addition, dispensing of powders and gums by volume (for example using a cup measure) is inherently inaccurate due to the variation in bulk density of the powders and gums.

Therefore, there would be an advantage if it were possible to provide a liquid edible gum viscosity-inhibited composition which only expresses its viscosity when added to a hot or cold food or beverage, which may overcome at least some of the above-mentioned disadvantages or provide a useful or commercial choice.

### SUMMARY OF THE INVENTION

In one form, although it need not be the only or indeed the broadest form, the invention resides in a stable liquid composition of less than 7500 cP comprising at least one edible gum and at least one viscosity inhibiting carrier, wherein addition of the composition to a hot or cold foodstuff increases the viscosity of the foodstuff to greater than 400 cP.

In another form, the invention resides in a stable liquid composition of less than 7500 cP comprising at least one edible gum and more than one viscosity inhibiting carrier, wherein addition of the composition to a hot or cold foodstuff increases the viscosity of the foodstuff to greater than 400 cP

In another form, the invention resides in a method of increasing the viscosity of a hot or cold foodstuff to greater than 400 cP, the method comprising addition to the foodstuff of stable liquid composition of less than 7500 cP comprising at least one edible gum and at least one viscosity inhibiting carrier.

In a further form the invention resides in a method of providing a foodstuff with viscosity of at least 400 cP to feed a person suffering from dysphagia, the method comprising addition to the foodstuff of a stable liquid composition of less than 7500 cP comprising at least one edible gum and at least one viscosity inhibiting carrier.

In a further form, the invention resides in a method of manufacturing a stable liquid composition comprising adding at least one edible gum to at least one viscosity inhibiting carrier and mixing the composition; wherein the viscosity of the composition is less than 7500 cP and the composition is stable for at least six months.

In a further form, the invention resides in a method of manufacturing a stable liquid composition comprising adding at least one edible gum to more than one viscosity inhibiting carrier and mixing the composition; wherein the viscosity of the composition is less than 7500 cP and the composition is stable for at least six months.

In a further form, the invention resides in a stable liquid composition made by the methods described above, the composition comprising at least one edible gum and at least one viscosity inhibiting carrier, or more than one viscosity inhibiting carrier, wherein the viscosity of the composition is less than 7500 cP.

The invention allows the viscosity of a hot or cold foodstuff to be increased in a predictable and repeatable manner. This is particularly important in the preparation of foodstuffs for persons suffering from dysphagia where the viscosity of the foodstuff is critical. Particularly, a liquid edible gum viscosity-inhibited composition of the invention permits easy and accurate dispensing via a precision volumetric pump.

The edible gums can include one or more of any practicable edible gum, including guar gum, xanthan gum, agar, alginic acid/sodium alginate, beta glucan, carrageenan, gum Arabic, gum tragacanth, locust bean gum, carboxymethylcellulose, methylcellulose, hydroxypropyl methylcellulose, gum ghatti, gum karaya, pectin (high methoxy and low methoxy), larch gum, fucellaran, starches, gelatin, and gellan gum.

The viscosity inhibiting carrier can include one or more than one carrier selected from the list including concentrated sugar solution, invert sugar, concentrated polydextrose solution, ethanol, glycerol, sorbitol, vegetable oil for example canola oil, propylene glycol, triacetin, and alcohols.

In order that the invention may be more readily understood and put into practice, one or more preferred embodiments thereof will now be described, by way of example only.

### DETAILED DESCRIPTION OF THE INVENTION

The invention advantageously provides a liquid composition which is flowable and stable, and when added to a hot or cold food or beverage, easily disperses the edible gum in the food or beverage to uniformly thicken the food or beverage to the desired viscosity. Using the composition of the invention, the viscosity of the thickened food or beverage can be predicted and reliably repeated.

As discussed previously, edible gums are usually provided in powder form or gel form and are difficult to disperse in a solution or foodstuff as they tend to form lumps in the solution. It is known that edible gums can be dispersed in a foodstuff by adding the powder into a product using high shear mixing to ensure efficient dispersion, or pre-blending the gum with another powder ingredient to separate the gum particles before they contact water. One of the problems with these techniques is that the gum expresses its viscosity once in solution, making it difficult to dispense the solution unless the gum concentration is low. This has implications for the addition of the solution to the foodstuff, as the viscosity and concentration of the end product will be affected by the amount of solution added. Edible gums can be dispersed using non-hydrating liquids, for example alcohol, glycerine, polyols or vegetable oils individually, however many of these liquids has its own disadvantages when trying to produce a stable product that has useable commercial shelf life.

Also, such solutions are sometimes not stable and must be used immediately or preservatised. Hence gum solutions of this type are not prepared, stored and marketed in this form, but normally kept in powdered form until just prior to use in the production of the food product.

The present invention provides a flowable liquid composition which is stable, and can be stored for up to 6 to 24 months without significant degradation in the performance of the thickener. The liquid composition of the invention is concentrated and can accommodate a higher percentage of edible gum without losing the flowable character of the composition. This enables easy and accurate dispensing of the formulation into the foodstuff of choice.

Because the composition of the invention is stable, and the viscosity remains constant for a commercially reasonable period of time, the formulation can be provided as a packaged product per se to the end user. The end user can reliably calculate the amount of the product of the invention to add to a food or beverage to achieve a desired end viscosity. The liquid composition of the invention is then easily dispensed and easily mixed into the foodstuff to give the desired end product.

Stability of the composition of the invention over time is indicated by retention of colour (if any), flavour (if any), and viscosity of the concentrate, clarity and ability to express viscosity to a predetermined level when added to a food or beverage.

Referring to the aspects of the invention summarised above, the viscosity inhibiting carrier or mixtures of carriers in which the edible gum is dispersed can be any practicable viscosity inhibitor or mixture of inhibitors which allows dispersion of the edible gum, while inhibiting the viscosity expression of the gum, until the composition is added to a foodstuff. The inventors have found a number of effective carriers and mixtures of carriers for use in the composition of the invention. More than one carrier can be combined in the liquid composition of the invention to maximise the efficacy of the composition.

An example of a viscosity inhibiting carrier of the invention is a concentrated sugar solution, or concentrated solution of a sugar derivative. The concentrated sugar or sugar derivative solution can include any practicable sugar, mixture of sugars, or sugar derivatives such as sucrose, fructose, glucose, maltose, or any other mono-, di-, tri- or polysaccharide, or a derivative such as polydextrose, which can be dissolved in water to high level of concentration. Other sources of sugars can also be used, for example fruit or vegetable juice concentrates. The amount of water needed to effect high concentration depends on the sugar or mixture of sugars being used. Concentrations can therefore range from 50%-90w/wt. Some of the sugar or sugar derivative soluble solids can be replaced with other food approved soluble solids like salt and food acids, up to a value of 30% of the total soluble solids, with the ultimate maximum level being determined by taste.

Further examples of carriers useful in the invention include ethyl alcohol, glycerol, sorbitol, concentrated erythritol solutions, isomalt, lactitol, mannitol, maltitol, xylitol, triacetin, propylene glycol, and vegetable and/or animal fats and oils.

Edible gum can be added to the composition of the invention in amounts ranging from 0.1 to 60%, depending on the carrier, the gum to be used, and the desired viscosity of the composition of the invention. The edible gum can be any edible gum or mixture of gums which will not hydrate in the carrier, and will therefore retain the flowable nature of the composition of the invention. Examples of such gums are guar gum, gum arabic, gum ghatti, gum karaya, gum tragacanth, psyllium seed gum, quince seed gum, pectins, larch gum, stractan, carrageenan, gelatin, gellan gum, tara gum, alginates, pregel starches, cellulose gums, xanthan gum, locust bean gum, and mixtures of any of the foregoing.

The viscosity of the liquid composition of the invention can be between 400 cP and 7500 cP making the composition flowable and easy to package and dispense.

The liquid composition of the invention can also include other components such as colours, flavours, protein (animal and plant), dietary fibres, vitamins and minerals, humectants, for example glycerol and sorbitol, fats and oils, emulsifiers, acidity regulators, antioxidants, low calorie bulking agents, firming agents, flavour enhancers, foaming agents, gelling agents, preservatives, sequestrants, stabilisers.

Ingredients that normally hydrate and thicken, for example proteins, dietary fibre, bulking agents, would also be inhibited from hydrating and thickening in the composition of the invention, meaning that these ingredients can also be used in higher levels in a concentrate of the composition of the invention, without unduly affecting the viscosity of the composition.

The manufacture of the composition of the invention can include a step of heating the carrier to assist dispersion of the gum. The heated composition can be hot-fill packaged, or cooled prior to packaging.

It is clear from the above description that the invention provides a product with many advantages over those currently available. The composition of the invention allows production and provision of a stable, flowable liquid composition for easy addition to a hot or cold food or beverage. The desired viscosity of the end product can be reliably and repeatably adjusted by adjusting the amount of flowable composition added to the food or beverage.

The following non-limiting Examples describe aspects of the invention for illustrative purposes.

### Example 1

### Method of Manufacture

The following general method is used for manufacture of a liquid composition of the invention, and used in respect of some of the Examples below.
Sugar is dissolved in water substantially to saturation, or alternatively a fruit or vegetable concentrate may be used;
The saturated solution is heated to between 30° C. and 80° C.;
The edible gum is added to the warmed solution and mixed to disperse;
Other additives such as citric acid, colours, flavourants are added to the solution and mixed to dissolution;

The resultant composition is either hot-fill packaged, or cooled to room temperature and cold-fill packaged.

### Example 2

### Composition 1

| | |
|---|---|
| Apple concentrate 70Bx | 95% |
| Guar Gum | 3% |
| Citric Acid | 1% |
| Food flavours | 0.5% |
| Food colours | 0.5% |

Using the method described in Example 1 above, this composition is a flowable liquid of 500 cP that disperses easily in water to reliably and repeatably give an end product solution of 1000 cP.

### Example 3

### Composition 2

| | |
|---|---|
| Sucrose | 66% |
| Water | 27% |
| Guar Gum | 5% |
| Citric Acid | 1% |
| Food flavours | 0.5% |
| Food colours | 0.5% |

Using the method described in Example 1 above, this composition is a flowable liquid of 900 cP that disperses easily in water to reliably and repeatably give an end product of 4500 cP.

### Example 4

### Composition 3

| | |
|---|---|
| Polydextrose | 44% |
| Water | 35% |
| Guar Gum | 10% |
| Maltodextrin | 6.8% |
| Glycerine | 2% |
| Sorbitol | 2% |
| Citric Acid | 0.2% |
| Sodium Citrate | 0.1% |
| Xanthan Gum | 0.06% |

Polydextrose is dissolved in water substantially to saturation;
The saturated solution is heated to between 30° C. and 80° C.;
The guar gum and xanthan gum are added to the warmed solution and mixed to disperse; The remaining components are added to the solution and mixed to dissolution;
The resultant composition is either hot-fill packaged, or cooled to room temperature and cold-fill packaged.
   This composition is a flowable liquid of 1500 cps that disperses easily in water to reliably and repeatably give viscosities in the range of 500 to 10,000 cps as determined by fixing the ratio of the weight of Composition 3 to the weight of water, or other food liquid such as milk, juice or tea.

### Example 5

### Composition 4

| | |
|---|---|
| Ethanol | 30% |
| Propylene glycol | 19.2% |
| Xanthan Gum | 30% |
| Carboxymethylcellulose (CMC) | 0.2% |
| Water | 20% |

The CMC is dispersed in the water and allowed to hydrate.
The alcohol is added to the CMC/water blend, followed by the propylene glycol
The mixture is mixed well
Xanthan gum is added and mixed well.
Other additives such as citric acid, colours, flavourants can be added to the mix if desired.
The composition is filled into packaging.
   This composition is a flowable liquid of 400 cps that disperses in water, or other liquid food, easily and repeatedly to give an end product of 1000 cps when 3 grams of the composition is added to 200 ml of water (or other liquid).

Throughout the specification the aim has been to describe the preferred embodiments of the invention without limiting the invention to any one embodiment or specific collection of features.

Throughout this specification, unless the context requires otherwise, the word “comprises”, and variations such as “comprise” or “comprising”, will be understood to imply the inclusion of a stated integer or group of integers or steps but not to the exclusion of any other integer or group of integers.

Any reference to publications cited in this specification is not an admission that the disclosures constitute common general knowledge in Australia.

1.-20. (canceled)

21. A temperature-insensitive stable liquid composition of less than 7500 cP comprising at least one edible gum and at least one viscosity inhibiting carrier, wherein addition of the composition to a hot or cold foodstuff increases the viscosity of the foodstuff to greater than 400 cP, wherein the at least one viscosity inhibiting carrier is selected from the group consisting of: concentrated polydextrose solution, concentrated maltodextrin solution, concentrated sugar solution, fruit or vegetable juice concentrate, invert sugar, alcohol, glycerol, sorbitol, vegetable oil, propylene glycol, triacetin, lecithin and n-propanol; and wherein the composition is stable for at least six months.

22. The temperature-insensitive stable liquid composition of claim 21 wherein, when there is one viscosity inhibiting carrier, the viscosity inhibiting carrier is selected from concentrated polydextrose solution, concentrated sugar solution and fruit or vegetable juice concentrate.

23. The temperature-insensitive stable liquid composition of claim 21 wherein the at least one viscosity inhibiting carrier includes triacetin when the viscosity inhibiting carriers include glycerol or propylene glycol.

24. The composition of claim 21 wherein the at least one edible gum is selected from the group consisting of guar gum, xanthan gum, locust bean gum, carboxymethylcellulose, methylcellulose, hydroxypropyl methylcellulose, pectin, and gellan gum.

25. The composition of claim 21 wherein the at least one edible gum is selected from the group consisting of galactomannans and the viscosity inhibiting carriers are selected from the group consisting of concentrated sugar solutions and concentrated polydextrose solution.

26. The composition of claim 21 wherein the at least one edible gum is selected from the group consisting of gums derived from bacterial fermentation and the viscosity inhibiting carrier or carriers is selected from the group consisting of alcohols and triglycerides.

27. A method of increasing the viscosity of a hot or cold foodstuff to greater than 400 cP, the method comprising addition to the foodstuff of temperature-insensitive stable liquid composition of less than 7500 cP comprising at least one edible gum and at least one viscosity inhibiting carrier; wherein the at least one viscosity inhibiting carrier is selected from the group consisting of: concentrated polydextrose solution, concentrated maltodextrin solution, concentrated sugar solution, fruit or vegetable juice concentrate, invert sugar, alcohol, glycerol, sorbitol, vegetable oil, propylene glycol, triacetin, lecithin and n-propanol; and wherein the composition is stable for at least six months.

28. The method of claim 27 wherein when there is one viscosity inhibiting carrier, the viscosity inhibiting carrier is selected from concentrated polydextrose solution, concentrated sugar solution and fruit or vegetable juice concentrate

29. The method of claim 27 further including the step that when the viscosity inhibiting carriers include glycerol or propylene glycol, triacetin is also included.

30. The method of claim 27 wherein the at least one edible gum is selected from the group consisting of guar gum, xanthan gum, locust bean gum, carboxymethylcellulose, methylcellulose, hydroxypropyl methylcellulose, pectin, and gellan gum.

31. The method of claim 27 wherein the at least one edible gum is selected from the group consisting of galactomannans and the viscosity inhibiting carrier or carriers is selected from the group consisting of concentrated sugar solutions and concentrated polydextrose solution.

32. The method of claim 27 wherein the at least one edible gum is selected from the group consisting of gums derived from bacterial fermentation and the viscosity inhibiting carrier or carriers is selected from the group consisting of alcohols and triglycerides.

33. The method of increasing the viscosity of a foodstuff to at least 400 cP, the method comprising: providing a pre-packaged, temperature-insensitive stable liquid composition of less than 7500 cP comprising at least one edible gum and at least one viscosity inhibiting carrier, wherein the at least one viscosity inhibiting carrier is selected from the group consisting of: concentrated polydextrose solution, concentrated maltodextrin solution, concentrated sugar solution, fruit or vegetable juice concentrate, invert sugar, alcohol, glycerol, sorbitol, vegetable oil, propylene glycol, triacetin, lecithin and n-propanol; and wherein the composition is stable for at least six months; and adding the composition to the foodstuff with agitation.

34. The method of claim 33 wherein when there is one viscosity inhibiting carrier, the viscosity inhibiting carrier is selected from concentrated polydextrose solution, concentrated sugar solution and fruit or vegetable juice concentrate.

35. The method of claim 33 wherein the foodstuff is used to feed persons suffering from dysphagia.

36. The method of claim 33 wherein the at least one edible gum is selected from the group consisting of guar gum, xanthan gum, locust bean gum, carboxymethylcellulose, methylcellulose, hydroxypropyl methylcellulose, pectin, and gellan gum.

37. The method of claim 33 wherein the at least one edible gum is selected from the group consisting of gums derived from bacterial fermentation and the viscosity inhibiting carrier or carriers is selected from the group consisting of alcohols and triglycerides.
